(19) United States
(12) Patent Application Publication
(10) Pub. No.: US 2022/0148082 A1
(43) Pub. Date: May 12, 2022

(54) SYSTEMS AND METHODS FOR ETF CREATION AND REDEMPTION VIA BLOCKCHAIN

(71) Applicant: Wells Fargo Bank, N.A., San Francisco, CA (US)

(72) Inventor: Paul G. Lacey, Charlotte, NC (US)

(21) Appl. No.: 15/656,360

(22) Filed: Jul. 21, 2017

Related U.S. Application Data
(60) Provisional application No. 62/367,024, filed on Jul. 26, 2016.

(51) Int. Cl. G06Q 40/04; G06Q 20/40

(52) U.S. Cl. CPC G06Q 40/04; G06Q 20/40

(57) ABSTRACT

A method for performing an ETF transaction for a customer. The method includes receiving, by a processor of a financial institution computing system, an ETF request from the customer via a customer computing device, the ETF request including at least one of an ETF creation request and an ETF redemption request, sending the ETF request to a distributor computing system via a permissioned blockchain system, each of the financial institution and the distributor having access to the permissioned blockchain system, wherein the distributor creates and redeems shares of an ETF. The method further includes receiving a unique identifier associated with the ETF request from the distributor upon receipt of the ETF request, wherein the distributor creates and associates the unique identifier with the ETF request, publishing the unique identifier associated with the ETF request to the permissioned blockchain system, and completing the ETF request via the permissioned blockchain system.

### CROSS-REFERENCE TO RELATED APPLICATIONS

This application claims priority to U.S. Provisional Patent Application No. 62/367,024 entitled “SYSTEMS AND METHODS FOR ETF CREATION AND REDEMPTION VIA BLOCKCHAIN”, filed Jul. 26, 2016, incorporated herein by reference in its entirety.

### TECHNICAL FIELD

Embodiments of the present disclosure relate generally to the field of blockchain technology and digital assets.

### BACKGROUND

A blockchain is a publicly viewable, append-only, distributed ledger having wide application in the financial services industry. Blockchain entries consist of blocks of information that can include transactions, transaction record components, transaction entities, and the like. Blockchain-based systems can be used to manage ownership of digital assets.

An Exchange Traded Fund (ETF) is a security that trades on an exchange as an equity that seeks to replicate the performance of an index without the need to purchase the underlying components.

Restricted securities are securities acquired in unregistered, private sales from the issuing company or from an affiliate of the issuer. Investors typically receive restricted securities through private placement offerings, Regulation D offerings, employee stock benefit plans, as compensation for professional services, or in exchange for providing “seed money” or start-up capital to the company.

Rule 144(a) is a Securities and Exchange Commission (SEC) rule that defines types of restricted securities and the terms by which restricted securities may be traded. Regulation S (“Reg. S”) provides safe harbors for certain security offerings made outside the United States by both U.S. and foreign issuers.

Financial institutions (FIs) desire to make creation and redemption of ETF a more efficient and accurate process for their customers. Currently, creating and redeeming shares of an ETF can be cumbersome due to the lack of transparency regarding the transactions involved in the process. Additionally, creating and redeeming ETFs can create market volatility due to the large volumes of transactions lacking transparency of purpose.

### SUMMARY

A first example embodiment relates to a method of performing a transaction for a customer of a financial institution. The method includes receiving, by a processor of a financial institution computing system, an ETF request from the customer via a customer computing device, the ETF request including at least one of an ETF creation request and an ETF redemption request. The method further includes sending, by the processor, the ETF request to a distributor computing system via a permissioned blockchain system, each of the financial institution and the distributor having access to the permissioned blockchain system. The distributor creates and redeems shares of an ETF. The method further includes receiving, by the processor, a unique identifier associated with the ETF request from the distributor upon receipt of the ETF request. The distributor creates and associates the unique identifier with the ETF request. The method further includes publishing the unique identifier associated with the ETF request to the permissioned blockchain system, and completing, by the processor, the ETF request via the permissioned blockchain system.

Another example embodiment relates to an ETF management system of a financial institution for creating and redeeming ETF shares. The system includes a network interface configured to facilitate data transmission over a network, an ETF request generation circuit, and a permissioned ledger system. The ETF request generation circuit is configured to receive an indication of an ETF request from a customer of the financial institution. The permissioned ledger system is configured to send the ETF request to a distributor via a permissioned blockchain system and receive a unique identifier associated with the ETF request via the permissioned blockchain system.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a schematic diagram of an ETF management system, according to an example embodiment.

FIG. 2 is a flow diagram of interactions between a processing FI and a distributor in relation to the ETF management system of FIG. 1, according to an example embodiment.

FIG. 3 is a flow diagram of ETF creation via blockchain, according to an example embodiment.

FIG. 4 is a flow diagram of ETF redemption via blockchain, according to an example embodiment.

### DETAILED DESCRIPTION

ETF shares are regularly traded on various exchanges. However, adding units (creating additional shares) of an ETF or redeeming units (removing existing shares) of the ETF is complex. In order to create additional shares of an ETF, an authorized participant purchases defined amounts of every constituent security in the ETF bilaterally in the market, settles all of those constituents, and sells the constituents to the issuer of the ETF to receive the new shares of the ETF. In general, creating or redeeming shares of an ETF involves a significant amount of trading activity and corresponding validation between the broker and the eventual issuer. Additionally, shares are typically created or redeemed in large groups of shares. This process is cumbersome, lacks transparency, and leads to market volatility.

Referring generally to the figures, various embodiments refer to systems and methods for creating and redeeming digital assets, such as ETF shares, via a blockchain-based system. A blockchain-based system is set up between the FI and a distributor of the ETF that allows for non-public creation and redemption processes to occur between the FI and the distributor, while allowing third parties (e.g., issuers, brokers, exchanges, clearing and settlement service, etc.) across the industry to access information regarding the ETF and manage the ETF accordingly. Using the blockchain-based system for ETF creation and redemption can create market efficiency and reduce market volatility regarding ETFs. Orders to create new ETF shares are posted to the blockchain-based system and include a unique identifier. The orders then get filled with each constituent linked to the ETF share via the unique identifier. The unique ID persists throughout the life of the ETF shares such that the link between the ETF share and the underlying constituent is preserved. In one embodiment, brokers who have their own principal-based inventory can fulfill requests to purchase constituents of the ETF using the blockchain-based system.

The blockchain-based ETF management system solves technical problems associated with conventional ETF creation and redemption systems. According to various example embodiments, a blockchain system utilizes unique identifiers for each particular ETF that is created. Using unique identifiers to track the transactions and underlying constituents relating to an ETF results in a more efficient and accurate ETF redemption process. Assigning a unique identifier to an ETF additionally allows for a non-public transaction between the FI and the distributor of the shares of ETF, while still allowing for transparency and management of the ETF by third party participants. Additionally, the tracking of transactions on the blockchain results in transparency of purpose. Current ETF creation and redemption systems can create market volatility due to the large volumes of transactions occurring without transparency of purpose.

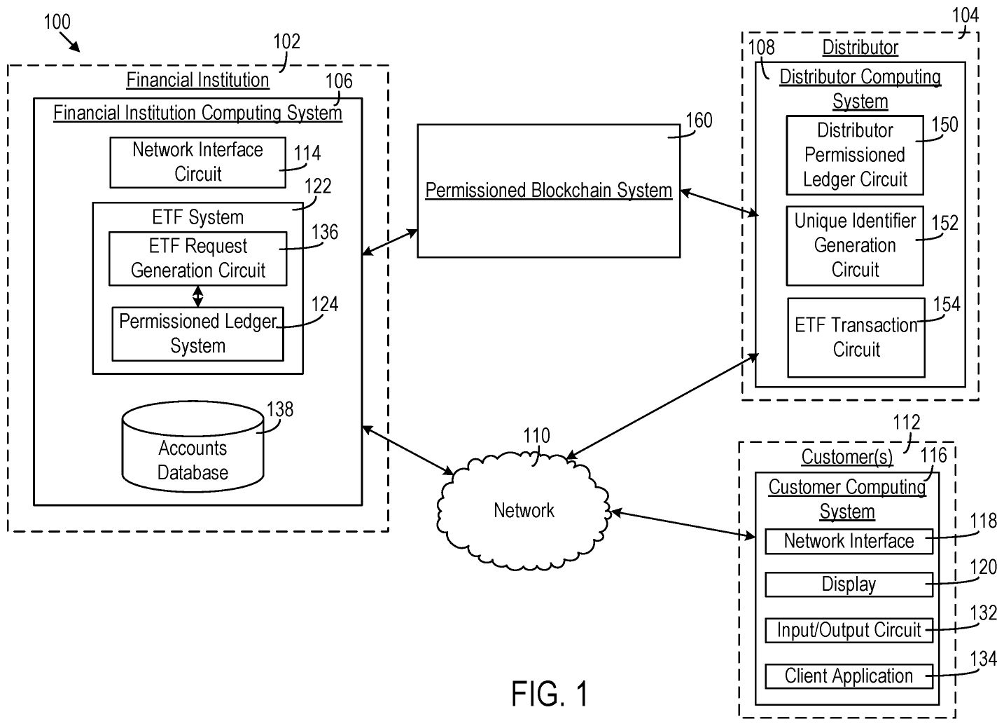

Referring to FIG. 1, a schematic diagram of an ETF management system 100 is shown, according to an example embodiment. As described in further detail below, the system 100 facilitates the creation and redemption of shares of an ETF by a customer 112 of an FI 102 using a permissioned blockchain system 160. As shown, the system 100 includes an FI computing system 106 communicably and operatively coupled to each of a distributor computing system 108, a permissioned blockchain system 160, and a customer computing system 116 associated with a customer 112, over a network 110. The network 110 may provide communicable and operative coupling between the customer computing system 116, FI computing system 106, distributor computing system 108, the permissioned blockchain system 160, and the other components disclosed and described herein to provide and facilitate the exchange of communications (e.g., data, instructions, values, commands, etc.). Accordingly, the network 110 may include any network including wired (e.g., Ethernet) and/or wireless networks (e.g., 802.11X, ZigBee, Bluetooth, Internet, WiFi). In some embodiments, the network 110 may further include a proprietary banking network to provide secure or substantially secure communications.

The FI 102 offers banking services to customers 112. The FI 102 offers ETF creation and redemption services through ETF system 122 within the FI computing system 106.

The distributor 104 is an authorized member of the permissioned blockchain system 160. The distributor 104 is an entity that creates a unique identifier for the ETF request and ultimately, distributes the shares of the ETF. Additionally, the distributor may be responsible for preparing and communicating the terms of the ETF to the FI 102. The permissioned blockchain system 160, described further herein, includes a distributed permission-based blockchain system, where members are authorized to participate. Other embodiments include a permissionless blockchain system in addition to, or instead of, the permission-based blockchain system. For example, for a permissionless blockchain system, an entity does not have to be recognized as having a previous relationship with the system (e.g., public blockchain systems, Bitcoin, etc.), whereas for a permission-based blockchain system, the entity must be recognized as having a previous relationship with the system (e.g., private blockchain systems, private FI systems). For example, in a permission-based blockchain system, an entity desiring to take part in the system must first be recognized and authorized to participate in the system. In some arrangements, the distributor 104 may not yet be an authorized member of the permissioned blockchain system 160 and may need to be authorized to proceed engaging with the FI through the system 100.

The permissioned blockchain system 160 may include transactions occurring between the FI 102 and the distributor 104. As such, the permissioned blockchain system 160 may be communicably and operatively coupled to both the FI computing system 106 and the distributor computing system 108 such that access to the system 160 is available to both the FI 102 and the distributor 104. As noted above, the permissioned blockchain system 160 may comprise a distributed permission-based blockchain system, where members are authorized to participate. Other embodiments include a permissionless blockchain system in addition to, or instead of, the permission-based blockchain system.

In one embodiment, each ETF share creation is assigned a separate unique identifier by the distributor 104 before or as the shares are distributed. The assignment of the unique identifier occurs in a non-public manner, where only the distributor 104 and the FI 102 have access to the underlying information regarding the unique identifier (e.g., customer information). Selection of the unique identifier can be done manually or automatically. For example, the distributor can manually assign a unique identifier to the creation units of the ETF or the ETF management system 100 can automatically select a unique identifier for the transaction.

The customer computing system 116 may include any type of computing system that may be used to interface with the FI computing system 106. The customer computing system 116 may include any type of computing system including, but not limited to, a phone (e.g., smartphone, etc.) and a computing device (e.g., tablet computer, laptop computer, desktop computer, personal digital assistant, etc.).

The customer 112 may be any person or entity using the customer computing system 116. In some arrangements, customers 112 are account holders with the FI 102. Customers 112 may use the FI 102 for banking services. For example, a customer 112 may have a deposit account, such as a savings account or a checking account serviced by the FI 102.

The FI computing system 106 may be associated with or operated by the FI 102 (e.g., a bank, a credit card issuer, etc.). The FI computing system 106 may be communicably and operatively coupled to the customer computing system 116 to facilitate interaction between customers 112 and the FI 102. Additionally, the FI computing system 106 is communicably and operatively coupled to the permissioned blockchain system 160 to facilitate creation and redemption of ETF shares.

The distributor computing system 108 may be associated with or operated by the distributor 104 (e.g., a bank, a credit card issuer, etc.). The distributor computing system 108 may be communicably and operatively coupled to the permissioned blockchain system 160 to facilitate interaction between the distributor 104 and the FI 102 via the network 110.

The following is an example interaction between the customer 112, FI 102, and distributor 104. The system 100 allows the customer 112 of the FI 102 to submit an ETF request (e.g., ETF creation request, ETF redemption request, etc.) to the FI 102 (received and processed by the FI computing system 106). For example, the ETF request is for creation of shares of an ETF. In this example, the customer 112 submits the ETF request to the FI 102. Next, the FI 102 communicates the request to the distributor 104. Using the permissioned blockchain system 160, a message is sent to the distributor 104 indicating the request and any information associated with that request (e.g., customer information, amount of currency to be invested, etc.). In one embodiment, the message including information associated with the request may be included in the metadata of the request. As such, no additional information needs to be transferred in the message. In another embodiment, a separate message including such information can be transferred along with the message indicating the request. In some embodiments, the creation of ETF shares and the associated unique identifier occurs exclusively within the permissioned blockchain system 160. In other embodiments, the request and creation of ETF shares includes activity outside the permissioned blockchain system 160 to complete the request. For example, the distributor 104 may need to affirm distribution of ETF creation units with an outside issuer. When the distributor 104 receives the request message, the distributor 104 communicates the terms of the ETF via the permissioned blockchain system 160 and assigns a unique identifier to the ETF creation request. The unique identifier is ultimately associated with the shares created from the ETF creation request within the permissioned blockchain system 160 and persists with those created ETF shares for the life of the shares.

The FI computing system 106 includes a network interface circuit 114 and an ETF system 122. In practice, the FI computing system 106 may include server computing systems, for example, comprising one or more networked computer servers having a processor and non-transitory machine readable media.

The network interface 114 may be used to establish connections with other components of the system 100 by way of network 110. The network interface 114 may include program logic that facilitates connection of the FI computing system 106 to the network 110. The network interface 114 may support communication between the FI computing system 106 and other systems, such as the customer computing system 116 and the distributor computing system 108. In some arrangements, the network interface 114 may include the hardware and machine-readable media sufficient to support communication over multiple channels of data communication. Further, the network interface 114 may include cryptography capabilities to establish a secure or relatively secure communication session between the FI computing system 106, customer computing system 116, and distributor computing system 108. In this regard, financial data (or other types of data) may be encrypted and transmitted to prevent or substantially prevent the threat of hacking.

The ETF system 122 includes an ETF request generation circuit 136 and a permissioned ledger system 124.

The ETF request generation circuit 136 is structured to receive ETF requests from customers 112 via the customer computing system 116. The ETF requests may include ETF creation requests and ETF redemption requests. The ETF request generation circuit 136 additionally communicates the ETF requests to the permissioned ledger system 124, which communicates the requests to the distributor 104. In one embodiment, the ETF requests can be communicated via the permissioned blockchain system 160. Alternatively, the ETF requests can be communicated via the network 110 to the distributor 104. The ETF request generation circuit 136 can be communicably and operatively coupled to an accounts database 138 at the FI 102 to receive information regarding the customer 112.

The permissioned ledger system 124 is structured to facilitate communication between the FI 102 and the permissioned blockchain system 160. Some communication between the FI 102 and the distributor 104 may occur via network 110. In some contemplated embodiments, a portion of the communication between the FI 102 and the distributor occurs via the blockchain system 160 (e.g., unique identifier creation and association) and another portion occurs via the network 110.

The distributor computing system 108 includes a distributor permissioned ledger circuit 150, an ETF transaction circuit 154, and a unique identifier circuit 152.

The permissioned ledger circuit 150 is structured to receive the ETF requests sent by the ETF request generation circuit 136 of the FI 102 and communicate the ETF requests to the ETF transaction circuit 154 and unique identifier circuit 152. As such, the permissioned ledger circuit 150 is communicably and operatively coupled to the ETF transaction circuit 154 and the unique identifier circuit 152. The permissioned ledger circuit 150 additionally receives customer information related to the ETF requests sent by the FI 102. In one embodiment, the permissioned ledger circuit 150 is in communication with the permissioned ledger blockchain system 160 such that in some embodiments, the ETF requests can be received through the blockchain system 160. In other embodiments, the ETF requests are received outside the blockchain system 160 from the FI 102 via the network 110.

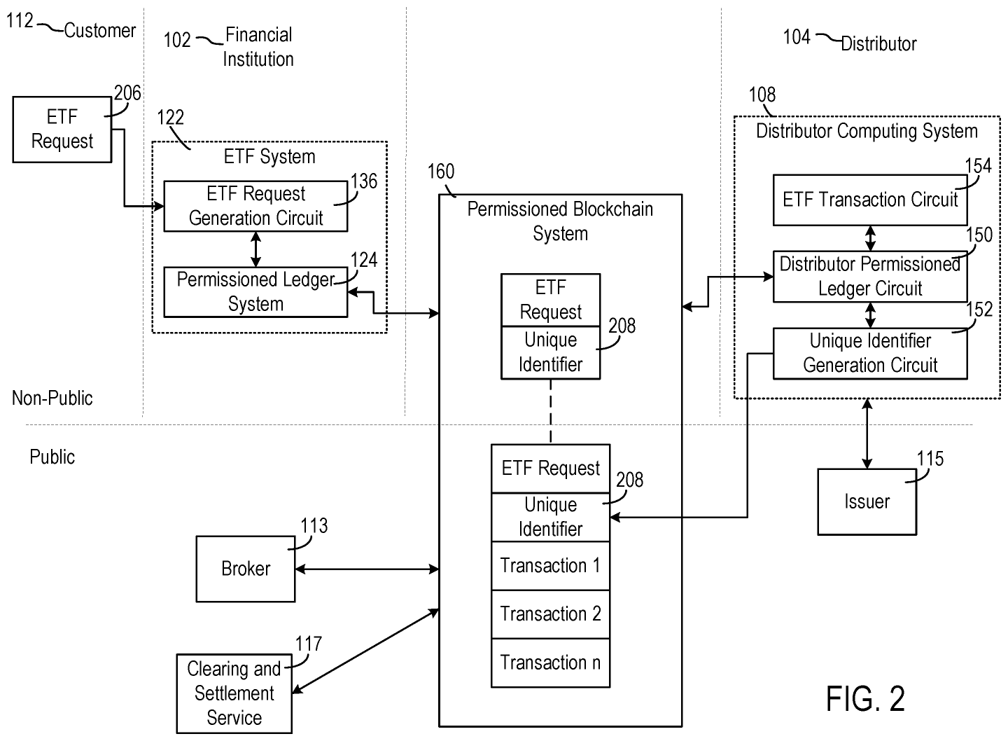

The unique identifier circuit 152 is structured to create and assign a unique identifier to each ETF request. As such, the unique identifier circuit 152 is communicably and operatively coupled to the permissioned ledger system 150 to receive an indication that an ETF request has been received by the distributor 104. The unique identifier may be a random or non-random alphanumeric string associated with the request (e.g., creation of ETF shares). The unique identifier is associated with the created ETF shares and persists throughout the life of the ETF shares such that each transaction occurring relating to those ETF shares can be tracked using the unique identifier. As discussed further below with regard to FIG. 2, after the creation and association of the unique identifier with the ETF request, the process can move from a non-public process to a public process. In some embodiments, simultaneous to or immediately after a unique identifier is created and associated with the ETF request, the permissioned blockchain system 160 can change from a permissioned-based system to a permissionless system to allow for access by third parties (e.g., broker, issuer, clearing and settlement service, etc.) to manage and view the transactions occurring on the blockchain. In other embodiments, the members included in the process shown in FIG. 2 have been authorized to participate in the ETF creation and redemption process.

The ETF transaction circuit 154 is structured to receive the ETF request from the permissioned ledger circuit 150 and complete the transaction request. The ETF transaction circuit 154 is structured to complete the transaction by buying the constituents of the ETF from the FI 102 and distributing new creation units to the FI 102 (e.g., ETF share creation). The ETF transaction circuit 154 is additionally structured to complete a redemption transaction by redeeming the shares of the ETF by selling the constituents of the ETF back to the FI 102 (e.g., ETF share redemption). The buying and selling of constituents of the ETF may occur via the permissioned blockchain system 160. Creation and redemption of ETF shares may additionally involve affirming the distribution and redemption of ETF shares via an issuer.

As shown, the customer computing system 116 includes a network interface 118, a display 120, an input/output circuit 132, and a client application 134.

The network interface 118 of the customer computing system 116 may be adapted for and configured to establish a communication session via the network 110 with the FI computing system 106. Accordingly, the network interface 118 may include any of a cellular transceiver (Code Division Multiple Access (CDMA), Global System for Mobile Communications (GSM), Long-Term Evolution (LTE), etc.), a wireless network transceiver (e.g., 802.11X, ZigBee, Bluetooth, etc.), or a combination thereof (e.g., both a cellular transceiver and a Bluetooth transceiver).

The display 120 may be used to present account information, transaction information, and the like to customers 112. In this regard, the display 120 may be communicably and operatively coupled to the input/output circuit 132 to provide a user interface for receiving and displaying information on the customer computing system 116.

The input/output circuit 132 may be structured to receive and provide communication(s) to the customer 112. In this regard, the input/output circuit 132 may be structured to exchange data, communications, instructions, etc. with an input/output component of the customer computing system 116. Accordingly, in one embodiment, the input/output circuit 132 may include an input/output device such as a display device, a touchscreen, a keyboard, and a microphone. In another embodiment, the input/output circuit 132 may include communication circuitry for facilitating the exchange of data, values, messages, and the like between an input/output device and the components of the customer computing system 116. In yet another embodiment, the input/output circuit 132 may include machine-readable media for facilitating the exchange of information between the input/output device and the components of the customer computing system 116. In still another embodiment, the input/output circuit 132 may include any combination of hardware components (e.g., a touchscreen), communication circuitry, and machine-readable media.

The client application 134 may comprise program logic (i.e., stored executable instructions) configured to implement at least some of the functions described herein. The client application 134 may simply be a web browser (e.g., Internet Explorer®, Chrome®, Safari®, etc.) configured to receive and display web pages received from the FI computing system 106. In other arrangements, the client application 134 may include a dedicated application (e.g., a smartphone application), a text message interface, or another program suitable for communicating with the FI computing system 106 over the network 110.

Referring now to FIG. 2, a flow diagram of interactions between customers 112, an FI (e.g., FI 102), a distributor (e.g., distributor 104), a broker (e.g., broker 113), an issuer (e.g., issuer 115), and a clearing and settlement service (e.g., clearing and settlement service 117) including use of the permissioned blockchain system 160 is shown, according to an example embodiment. As shown, all customer requests (e.g., ETF request 206) are received at an ETF request generation circuit 136 of the ETF system 122. The ETF request generation circuit 136 may communicate directly with customer devices (e.g., customer computing systems 116) via a network (e.g., network 110). The ETF request generation circuit 136 receives requests (e.g., ETF request 206), transaction information (e.g., amount of currency to be invested), customer information, and the like from customers 112. The ETF request generation circuit 136 communicates the request to the permissioned ledger system 124, which communicates the request via the permissioned blockchain system 160 to the distributor 104.

The ETF request is received at the distributor permissioned ledger circuit 150. The distributor permissioned ledger circuit 150 communicates the request to the unique identifier generation circuit 152. When the ETF request is for creation of ETF shares, the unique identifier generation circuit 152 creates a unique identifier for that ETF request and associates the unique identifier with the ETF request on the blockchain (e.g., unique identifier 208). Once the unique identifier 208 is assigned to the ETF request, the ETF request is completed via the blockchain system 160. The creation and assignment of the unique identifier 208 is a non-public process between the distributor 104 and FI 102. Simultaneous to or soon after the unique identifier 208 is created and assigned, the distributor 104 additionally communicates the terms of the ETF request.

After the unique identifier is created, the FI 102 submits an order for constituents via the blockchain system 160. The broker 113 sees the order for constituents on the blockchain associated with the unique identifier 208 and completes the order by selling constituents which will substantially track the performance of an index (e.g., a portfolio of securities) to the FI 102. The FI 102 will sell those constituents to the distributor 104 and the distributor 104 distributes the ETF shares to the FI 102 via the blockchain using the ETF transaction circuit 154. The distributor 104 affirms the distribution of the ETF shares to an issuer 115. Finally, the ETF creation will be cleared and settled with the clearing and settlement service 117 via the blockchain. Thus, all transactions occurring outside the creation of the unique identifier 208 are occurring in a public manner such that all parties (e.g., broker, issuer, clearing and settlement service, distributor, FI) are aware of each transaction and can track each transaction using the unique identifier 208.

The clearing and settlement service 117 is an entity providing clearance, settlement, and information services for ETFs, mutual funds, insurance carriers, corporate and municipal bonds, equities, and so on. In some embodiments, the clearing and settlement service 117 is the Depository Trust & Clearing Corporation (DTCC). The DTCC is a post-trade financial services company providing clearing and settlement services to financial markets. The process for clearing ETFs includes reviewing the ETF portfolio constituents. As such, the clearing and settlement process is facilitated by the use of the permissioned blockchain system 160 as the unique identifier 208 tracks the underlying portfolio constituents.

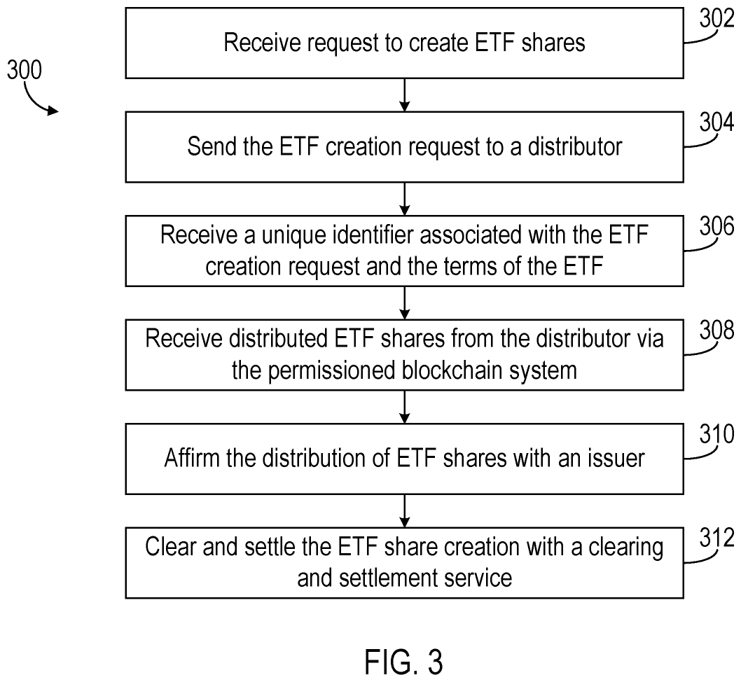

Referring now to FIG. 3, a method 300 of creating ETF shares using the ETF management system 100 of FIG. 1 is shown, according to an example embodiment. In describing method 300, references may be made to FIGS. 1-2. However, it should be understood that the method 300 may similarly be performed using other systems and devices.

At 302, a request to create ETF shares is received. The ETF request may include information relating to any of an identity of the customer and an amount of currency to be invested. In some arrangements, the request is transmitted from a user device (e.g., a personal computer, a smartphone, customer computing system 116, etc.) and received by the ETF request generation circuit 136 of the ETF system 122 of the FI 102. In other arrangements, the request is initiated by an employee of the FI 102 entering data into a computing system (e.g., an employee terminal connected to the server of the FI) during a person-to-person interaction. For example, the customer may walk into a branch location of the FI and initiate the deposit request via interaction with a teller at the branch.

At 304, upon receiving the request, the ETF creation request is sent to the distributor 104 via the permissioned blockchain system 160. The transmission of the request message may be performed by the permissioned blockchain system 160, as shown in FIG. 2. The permissioned ledger system 124 of the FI 102 may transmit the message to the permissioned blockchain system 160, which then transmits the message to the distributor 104.

At 306, a unique identifier is created and terms of the ETF are communicated to the FI. The unique identifier generation circuit 152 creates and assigns a unique identifier to the ETF generation request. The unique identifier is published to the blockchain and associated with the ETF request. The unique identifier is then made public to other entities on the blockchain 160, without revealing any underlying customer information. The unique identifier remains with the creation of ETF shares throughout the life of the shares such that each transaction involving the created shares can be tracked by all relevant parties.

At 308, ETF shares are distributed to the FI. The distribution of ETF shares can include many steps including: the FI submits an order for constituents to a broker via the blockchain system 160, the broker sells the constituents to the FI, the FI sells the constituents to the distributor, which in turn distributes the created ETF shares to the FI.

At 310, the distribution of ETF shares is affirmed with an issuer and at 312, after creation of the ETF shares, the transaction is cleared and settled with a clearing and settlement service via the blockchain. The underlying constituents of the ETF are tracked by the unique identifier 208 assigned to the ETF shares, which facilitates the process of clearance and settlement of the ETF.

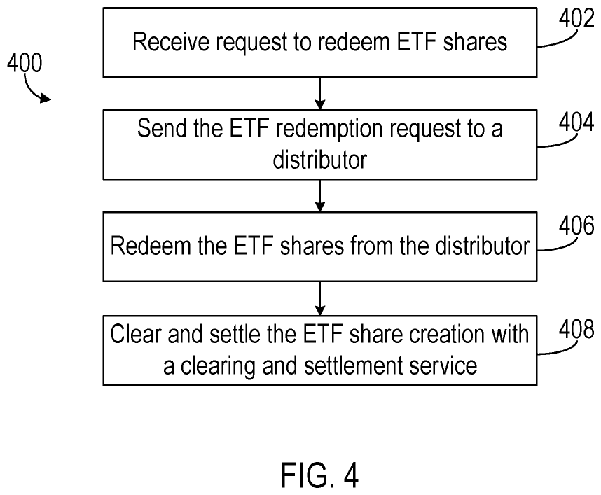

Referring now to FIG. 4, a method 400 of redeeming ETF shares using an ETF management system 100 is shown, according to an example embodiment. In describing method 400, references may be made to FIGS. 1-2.

At 402, a request to redeem ETF shares is received. The ETF request may include information relating to any of an identity of the customer and an amount of currency to be invested. In some arrangements, the request is transmitted from a user device (e.g., a personal computer, a smartphone, customer computing system 116, etc.) and received by the ETF request generation circuit 136 of the ETF system 122 of the FI 102. In other arrangements, the request is initiated by an employee of the FI 102 entering data into a computing system (e.g., an employee terminal connected to the server of the FI) during a person-to-person interaction. For example, the customer may walk into a branch location of the FI and initiate the deposit request via interaction with a teller at the branch.

At 404, upon receiving the redemption request at the FI, a redemption request is submitted to the distributor via the permissioned blockchain system. The transmission of the request message may be performed by the permissioned blockchain system 160, as shown in FIG. 2. The permissioned ledger system 124 of the FI 102 may transmit the message to the permissioned blockchain system 160, which then transmits the message to the distributor 104.

At 406, the ETF shares are redeemed from the distributor. The redemption request is received by the distributor permissioned ledger circuit 150 and using the unique identifier of the related shares, the distributor 104 redeems the ETF shares by selling the constituents of the ETF to the FI 102. In turn, the FI 102 sells the constituents of the index to the broker.

At 408, after redemption of the ETF shares, the transaction is cleared and settled with the clearing and settlement service via the blockchain system. The underlying constituents of the ETF are tracked by the unique identifier 208 assigned to the ETF shares, which facilitates the process of clearance and settlement of the ETF.

The blockchain-based system described above can additionally be used in a Reg. S/Rule 144(a) conversion of securities. When shares are issued, restrictions are placed on the shares under SEC rules and regulations. When the assets get traded in the market, a strict process must be followed. As part of that process, a transfer agent maintains the record of all issued share capital and wholesale within a corporation and the record of Reg. S security. To convert Reg. S security into Rule 144(a), a contract for transformation must be completed and an undefined period of time may pass before the contract is processed. Using a blockchain-based system, a series of transfer agents may be participants on the blockchain who can put in orders for conversion on the blockchain. In this situation, there would be no need to go into the market and purchase constituents.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A method of performing a transaction for a customer of a financial institution, the method comprising:
receiving, by a financial institution processor of a financial institution computing system, an exchange-traded fund (“ETF”) request from the customer via a customer computing device, the ETF request including an ETF creation request;
sending, by the financial institution processor, the ETF request to a distributor computing system associated with a distributor via a permissioned blockchain system, each of the financial institution and the distributor having access to the permissioned blockchain system;
receiving, by a distributor processor of the distributor computing system, the ETF request from the financial institution computing system via the permissioned blockchain system;
upon receiving the ETF request:
creating, by the distributor processor, a unique identifier and an ETF share; and
assigning, by the distributor processor, the unique identifier to the ETF request and the created ETF share,
wherein the creation and assignment of the unique identifier to the ETF request and the created ETF share is a non-public process between the distributor and the financial institution where only the distributor and the financial institution have access to customer information regarding the unique identifier;
receiving, by the financial institution processor, the unique identifier from the distributor computing system;
publishing the unique identifier to the permissioned blockchain system;
submitting, by the financial institution processor, an order for a plurality of constituents to a broker via the permissioned blockchain system, the order for the plurality of constituents including the unique identifier and being published to the permissioned blockchain system such that the order for the plurality of constituents is viewable by the broker;
purchasing, by the financial institution processor, the plurality of constituents from the broker via the permissioned blockchain system with each constituent linked to the created ETF share via the unique identifier; and
tracking, by the financial institution processor, the plurality of constituents using the unique identifier,
wherein each transaction involving the created ETF share and the plurality of constituents is publicly trackable via the permissioned blockchain system using the unique identifier.

2-3. (canceled)

4. The method of claim 1, further comprising:
selling, by the financial institution processor, the plurality of constituents to the distributor via the permissioned blockchain system; and
receiving, by the financial institution processor, the created ETF share from the distributor via the permissioned blockchain system.

5. The method of claim 4, further comprising:
tracking, by the financial institution processor, a plurality of transactions involving the created ETF share using the unique identifier via the permissioned blockchain system;
wherein the unique identifier is associated with each of the plurality of transactions involving the created ETF share.

6. The method of claim 5, further comprising:
affirming, by the distributor processor, a distribution of the created ETF share with an issuer via the permissioned blockchain system.

7. The method of claim 6, further comprising:
clearing and settling the created ETF share with a clearing and settlement service via the permissioned blockchain system.

8. The method of claim 7, wherein each of the plurality of transactions is published subsequent to the ETF request and the unique identifier on the permissioned blockchain system.

9. The method of claim 8, wherein the plurality of transactions are processed in a public manner such that the broker, the distributor, the issuer, and the clearing and settlement service can track each transaction of the plurality of transactions using the unique identifier on the permissioned blockchain system.

10. An exchange-traded fund (“ETF”) management system of a financial institution for creating ETF shares, the system comprising:
a network interface configured to facilitate data transmission over a network;
an ETF request generation circuit configured to:
receive an indication of an ETF request from a customer of the financial institution via the network, the ETF request including an ETF creation request; and
a permissioned ledger system configured to:
receive the ETF request from the ETF request generation circuit;
send the ETF request to a distributor via a permissioned blockchain system, the distributor creating a unique identifier and an ETF share and assigning the unique identifier to the ETF request and the created ETF share, wherein the creation and assignment of the unique identifier to the ETF request and the created ETF share is a non-public process between the distributor and the financial institution where only the distributor and the financial institution have access to customer information regarding the unique identifier;
receive the unique identifier from the distributor via the permissioned blockchain system;
publish the unique identifier to the permissioned blockchain system;
submit an order for a plurality of constituents to a broker via the permissioned blockchain system, the order for the plurality of constituents including the unique identifier and being published to the permissioned blockchain system such that the order for the plurality of constituents is viewable by the broker;
purchase the plurality of constituents from the broker via the permissioned blockchain system with each constituent linked to the created ETF share via the unique identifier; and
track the plurality of constituents using the unique identifier,
wherein each transaction involving the created ETF share and the plurality of constituents is publicly trackable via the permissioned blockchain system using the unique identifier.

11-13. (canceled)

14. The ETF management system of claim 10, wherein the permissioned ledger system is further configured to:
sell the plurality of constituents to the distributor via the permissioned blockchain system; and
receive the created ETF share from the distributor via the permissioned blockchain system.

15. The ETF management system of claim 14, wherein the permissioned ledger system is further configured to:
track a plurality of transactions involving the created ETF share using the unique identifier via the permissioned blockchain system;
wherein the unique identifier is associated with each of the plurality of transactions involving the created ETF share.

16. The ETF management system of claim 15, wherein the permissioned ledger system is further configured to:
affirm a distribution of the created ETF share with an issuer via the permissioned blockchain system.

17. The ETF management system of claim 16, wherein the permissioned ledger system is further configured to:
clear and settle the created ETF share with a clearing and settlement service via the permissioned blockchain system.

18. (canceled)

19. The ETF management system of claim 17, wherein the permissioned ledger system is further configured to publish each of the plurality of transactions subsequent to the ETF request and the unique identifier on the permissioned blockchain system.

20. The ETF management system of claim 19, wherein all transactions occurring outside creating, assigning and receiving the unique identifier are processed in a public manner such that the broker, the distributor, the issuer, and the clearing and settlement service can track each transaction using the unique identifier on the permissioned blockchain system.

21. A method of performing a transaction for a customer of a financial institution, the method comprising:
receiving, by a financial institution processor of a financial institution computing system, an exchange-traded fund (“ETF”) request from the customer via a customer computing device, the ETF request including an ETF creation request;
sending, by the financial institution processor, the ETF request to a distributor computing system associated with a distributor via a permissioned blockchain system, each of the financial institution and the distributor having access to the permissioned blockchain system;
receiving, by a distributor processor of the distributor computing system, the ETF request from the financial institution computing system via the permissioned blockchain system;
upon receiving the ETF request:
creating, by the distributor processor, a unique identifier and an ETF share; and
assigning, by the distributor processor, the unique identifier to the ETF request and the created ETF share,
wherein the creation and assignment of the unique identifier to the ETF request and the created ETF share is a non-public process between the distributor and the financial institution where only the distributor and the financial institution have access to customer information regarding the unique identifier;
receiving, by the financial institution processor, the unique identifier from the distributor computing system;
publishing the unique identifier to the permissioned blockchain system;
submitting, by the financial institution processor, an order for a plurality of constituents to a broker via the permissioned blockchain system, the order for the plurality of constituents including the unique identifier and being published to the permissioned blockchain system such that the order for the plurality of constituents is viewable by the broker;
purchasing, by the financial institution processor, the plurality of constituents from the broker via the permissioned blockchain system with each constituent linked to the created ETF share via the unique identifier;
tracking, by the financial institution processor, the plurality of constituents using the unique identifier;
selling, by the financial institution processor, the plurality of constituents to the distributor via the permissioned blockchain system;
receiving, by the financial institution processor, the ETF share from the distributor via the permissioned blockchain system;
affirming, by the financial institution processor, a distribution of the created ETF share with an issuer via the permissioned blockchain system; and
clearing and settling, by the financial institution processor, the created ETF share with a clearing and settlement service via the permissioned blockchain system,
wherein each transaction involving the created ETF share and the plurality of constituents is publicly trackable via the permissioned blockchain system using the unique identifier.
